(19) United States
(12) Patent Application Publication
(10) Pub. No.: US 2017/0147744 A1
(43) Pub. Date: May 25, 2017

(54) SYSTEM FOR ANALYZING SEQUENCING DATA OF BACTERIAL STRAINS AND METHOD THEREOF

(71) Applicant: INSTITUTE FOR INFORMATION INDUSTRY, Taipei (TW)

(72) Inventors: Chia-Yang CHENG, Taipei City (TW); Joey Jen-Hui, SYU, Nantou County (TW); Wei-I LIU, Kaohsiung City (TW); Mong-Hsun TSAI, New Taipei City (TW); Tzu-Pin LU, Taipei City (TW); Liang-Chuan LAI, Taipei City (TW); Eric-Y CHUANG, Taipei City (TW)

(21) Appl. No.: 14/963,196

(22) Filed: Dec. 8, 2015

(30) Foreign Application Priority Data
Nov. 20, 2015 (TW) 104138505

(51) Int. Cl. G06F 19/22

(52) U.S. Cl. CPC G06F 19/22

(57) ABSTRACT

A system for analyzing sequencing data of bacterial strains and a method thereof are provided. The method for analyzing sequencing data of bacterial strains includes the following steps: searching a specific variable region of a first genetic sample sequence and searching another specific variable region of a second genetic sample sequence; determining whether both the specific variable region and the another specific variable region have an identical cross-sample subsequence; if both the specific variable region and the another specific variable region have the identical cross-sample subsequence, storing the cross-sample subsequence into a recording table; and if the identical cross-sample subsequence exists, comparing the cross-sample subsequence with a plurality of gene sequences of known strains stored in a database module to analyze a plurality of strains corresponding to the cross-sample subsequence in the first genetic sample sequence and the second genetic sample sequence.

### RELATED APPLICATIONS

This application claims priority to Taiwan Application Serial Number 104138505, filed Nov. 20, 2015, the entirety of which is herein incorporated by reference.

### BACKGROUND

Field of Invention

The present invention relates to a system for analyzing sequencing data of bacterial strains and a method thereof, and in particular to a system for detecting single-sample or cross-sample repeated sequences and analyzing sequencing data of bacterial strains and a method thereof.

Description of Related Art

As the biotechnology is developed increasingly, the work of gene sequencing is more and more complete, and the study on human-body symbiotic bacteria becomes very important. Currently, it is known that there are 100 trillion symbiotic bacteria on the human body, and the number of the symbiotic bacteria is ten times more than that of all cells of the human body. In addition, symbiotic bacteria also exist in the gastrointestinal tract, the skin, the oral cavity, the respiratory tract and the genital tract of the human body; the symbiotic bacteria are collectively referred to as microflora, and the microflora is closely related to immunity, metabolism, development, the nervous system and the like.

Herein, it is known that scientists deconstruct species distribution of the human enterobacteria by utilizing sequencing of 16S ribosome RNA (16S rRNA) sequences. Therefore, bacteria can be distinguished by utilizing the steps of tagging 16S rRNA genes and amplifying and replicating sequence, performing sequencing, performing prepositioning according to the sequencing quality and performing de novo and re-sequence on the sequences according to a 16S rRNA database. Species having higher similarity are classified into the same operational taxonomic unit (OTU), and finally statistical analysis is performed on microflora difference of different samples.

However, conventionally, if it wants to analyze multiple groups of sample data, it needs to spend considerable time and calculation amount, and it has become one of to-be-solved problems in the field how to reduce the calculation amount of the system and improve the speed of analyzing sample data.

### SUMMARY

To solve the above-mentioned problem, an aspect of the present invention provides a system for analyzing sequencing data of bacterial strains. The system for analyzing sequencing data of bacterial strains includes a single-sample repeated sequence removal module, a cross-sample repeated sequence determining module, a repeated sequence recording module, and an calculating and re-sequencing module. The single-sample repeated sequence removal module is used for searching a first conservative region and a specific variable region in a first genetic sample sequence, and removing the first conservative region. The cross-sample repeated sequence determining module is used for determining whether the specific variable region has a cross-sample subsequence and the cross-sample subsequence is the same as an another specific variable region in a second genetic sample sequence. The repeated sequence recording module is used for storing the cross-sample subsequence into a recording table when the specific variable region has the cross-sample subsequence and the cross-sample subsequence is the same as the another specific variable region in a second bacterial sample. The calculating and re-sequencing module is used for comparing the cross-sample subsequence with multiple gene sequences of known strains stored in a database module when the identical cross-sample subsequence exists, so as to analyze strains corresponding to the cross-sample subsequence in the first genetic sample sequence and the second genetic sample sequence.

Another aspect of the present invention provides a method for analyzing sequencing data of bacterial strains. The method for analyzing sequencing data of bacterial strains includes the steps of searching a specific variable region of a first genetic sample sequence and searching another specific variable region of a second genetic sample sequence; determining whether both the specific variable region and the another specific variable region have the identical cross-sample subsequence; if both the specific variable region and the another specific variable region have the identical cross-sample subsequence, storing the identical cross-sample subsequence into a recording table; and when the identical cross-sample subsequence exists, comparing the identical cross-sample subsequence with multiple gene sequences of known strains stored in a database module, so as to analyze strains corresponding to the identical cross-sample subsequence in the first genetic sample sequence and the second genetic sample sequence.

In view of the above, compared with the prior art, the technical solution of the present invention has obvious advantages and beneficial effects. With the aforementioned technical solution, a considerable technical progress can be achieved with the value of being widely applied in the industry. According to the disclosure, the calculation amount can be reduced for the system for analyzing sequencing data of bacterial strains so that the speed of analyzing sample data can be improved.

### BRIEF DESCRIPTION OF THE DRAWINGS

In order to make the foregoing as well as other aspects, features, advantages and embodiments of the present invention more apparent, the accompanying drawings are described as follows:

FIG. 1 illustrates a block diagram of a system for analyzing sequencing data of bacterial strains according to an embodiment of the present invention;

FIG. 2 illustrates a flow chart of a method for analyzing sequencing data of bacterial strains according to an embodiment of the present invention;

FIG. 3 illustrates a schematic view of a genetic sample sequence according to an embodiment of the present invention; and

FIGS. 4A-4C illustrate schematic views of a gene fragment according to an embodiment of the present invention.

### DETAILED DESCRIPTION

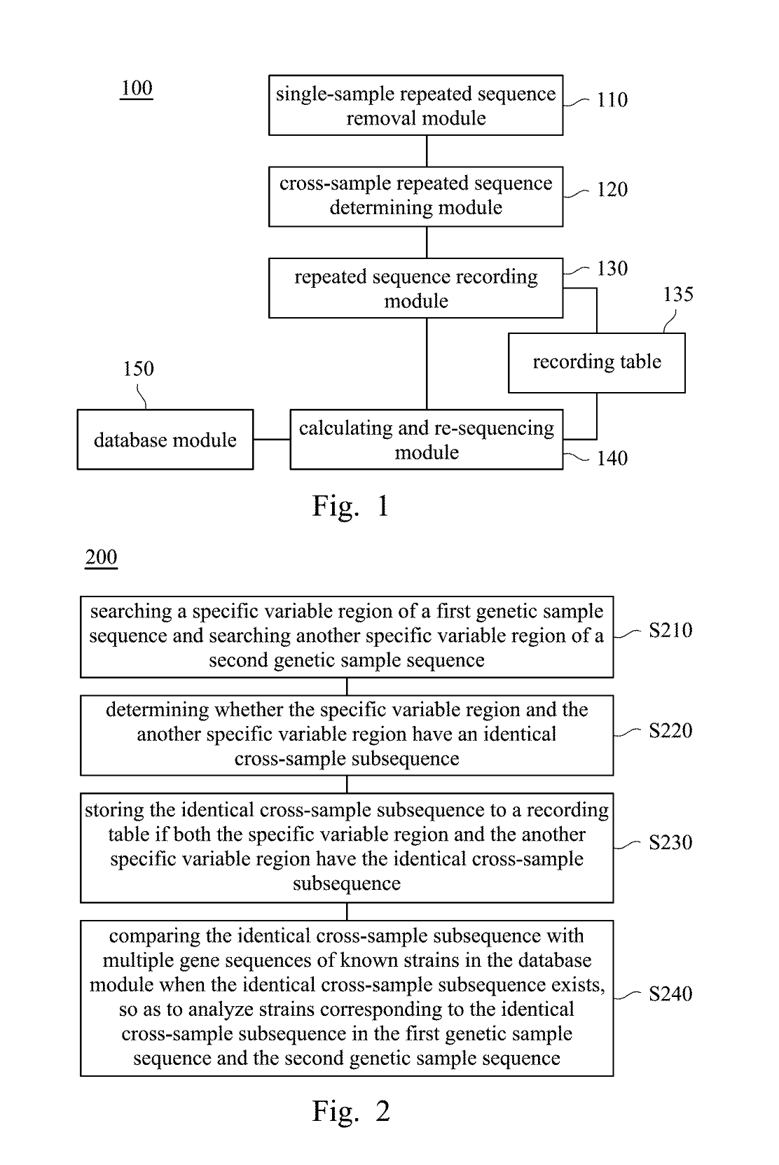

Referring to FIG. 1, FIG. 1 illustrates a block diagram of a system 100 for analyzing sequencing data of bacterial strains according to an embodiment of the invention.

The system 100 for analyzing sequencing data of bacterial strains includes a single-sample repeated sequence removal module 110, a cross-sample repeated sequence determining module 120, a repeated sequence recording module 130 and an calculating and re-sequencing module 140. The single-sample repeated sequence removal module 110 is used for searching a first conservative region and a specific variable region in a first genetic sample sequence, and removing the first conservative region. The cross-sample repeated sequence determining module 120 is used for determining whether the specific variable region has the cross-sample subsequence and the cross-sample subsequence is the same as an another specific variable region in a second genetic sample sequence. The repeated sequence recording module 130 is used for storing the cross-sample subsequence into a recording table 135 when the specific variable region has the cross-sample subsequence and the cross-sample subsequence is the same as another specific variable region in a second bacterial sample. The calculating and re-sequencing module 140 is used for comparing the cross-sample subsequence with multiple gene sequences of known strains stored in a database module 150 when the identical cross-sample subsequence exists, so as to analyze strains corresponding to the cross-sample subsequence in the first genetic sample sequence and the second genetic sample sequence.

Herein, as shown in FIG. 1, the database module 150 can be embodied in a read-only memory, a flash memory, a floppy disk, a hard disk, an optical disk, a flash drive, a tape, a database accessible from the network or a storage medium which can be easily thought of by those skilled in the art and have the identical function. The recording table 135 can be a file and is stored in any electronic device having a storage function. In addition, the single-sample repeated sequence removal module 110, the cross-sample repeated sequence determining module 120, the repeated sequence recording module 130 and the calculating and re-sequencing module 140 can be embodied respectively or together through for example a microcontroller, a microprocessor, a digital signal processor, an application specific integrated circuit (ASIC) or a logic circuit.

As described above, the system 100 for analyzing sequencing data of bacterial strains can remove the identical or repeated gene segments in a single sample and store cross-sample subsequences and the relations between the cross-sample subsequences and bacterial samples into the recording table 135 by finding out the identical or repeated cross-sample subsequences in a cross-sample way, and a simplified data structure can be established for plenty of cross-sample subsequences having repeating properties by utilizing the recording table 135. By means of these methods, it is avoided that the calculating and re-sequencing module 140 repeatedly makes a comparison between plenty of identical or repeated gene fragments in the single sample or cross-samples and known data stored in the database module 150, and the calculation amount can be reduced for the system 100 for analyzing sequencing data of bacterial strains so that the speed of analyzing sample data can be improved.

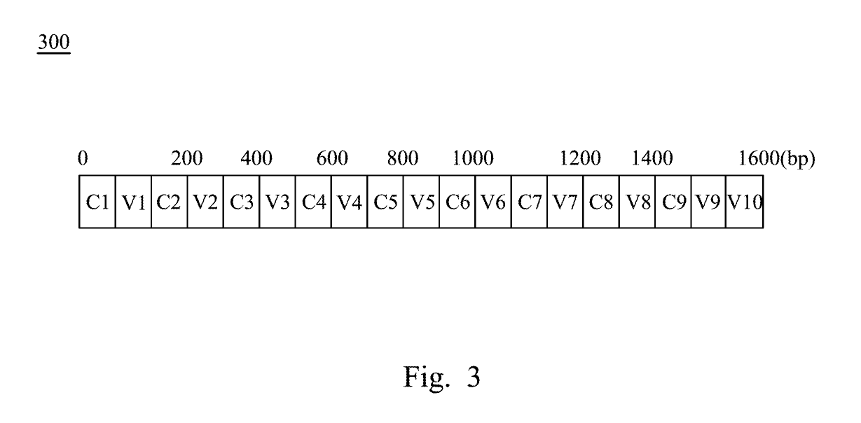

A method 200 for analyzing sequencing data of bacterial strains is further described and analyzed below. Referring to FIGS. 1-3, FIG. 2 illustrates a flow chart of a method 200 for analyzing sequencing data of bacterial strains according to an embodiment of the invention. FIG. 3 illustrates a schematic view of a genetic sample sequence 300 according to an embodiment of the invention. For convenience in description, the system 100 for analyzing sequencing data of bacterial strains as shown in FIG. 1 is described together with the method 200 for analyzing sequencing data of bacterial strains and the genetic sample sequence 300 through examples.

In step S210, the single-sample repeated sequence removal module 110 is used for searching a specific variable region of a first genetic sample sequence and searching another specific variable region of a second genetic sample sequence. In one embodiment, the specific variable region of the first genetic sample sequence and the another specific variable region of the second genetic sample sequence can respectively refer to any section of variable region in the first genetic sample sequence and the second genetic sample sequence.

In one embodiment, the system 100 for analyzing sequencing data of bacterial strains further includes a sample sampling module (not shown) and a gene sequencing module (not shown). The sample sampling module is used for collecting multiple bacterial samples, and the bacterial samples include a first bacterial sample and a second bacterial sample. The gene sequencing module is used for respectively performing gene sequencing on the bacterial samples, so as to obtain a first genetic sample sequence corresponding to the first bacterial sample and a second genetic sample sequence corresponding to the second bacterial sample.

For example, when some user undergoes colonoscopy, if it is found that the user's large intestine has polyp, the sample sampling module can perform sampling the polyp part, and sampling is also performed at the position near the polyp that seems normal, so as to obtain multiple bacterial samples. Herein, each bacterial sample may have 300 thousand genetic data, and the data are usually mixed with multiple bacteria harmful or good to the human body. Therefore, these genetic sample sequences are respectively compared with known data stored in the database module 150, and through comparison it is found that both are the identical (for example, the first genetic sample sequence is the identical as a gene sequence of some known strain stored in the database module 150), and thus the strain corresponding to the genetic sample sequence can be determined. For example, after 30 bacterial samples are collected in total, gene sequencing is performed by utilizing the gene sequencing module, and the gene sequencing module is, for example, a sequencer, can extract deoxyribose nucleic acid (DNA) of each bacterial sample and respectively obtain at least one genetic sample sequence corresponding to each bacterial sample.

In addition, in another embodiment, when the gene sequencing module needs to perform sequencing to obtain a variable region with a gene sequence length of 500 base pairs (bp) while the sequencer can only perform sequencing to reach a gene sequence length of 100 bp, the sequencer can be set as duplicating gene sequences in large quantities, randomly break up the gene sequences duplicated in large quantities and obtain each broken small fragment with a gene sequence length of 100 bp so as to perform sequentially, and finally the sequencer combines each small fragment having undergone sequencing. By means of the method, a gene sequence with a large length can be sequenced.

In one embodiment, the single-sample repeated sequence removal module 110 can receive multiple genetic sample sequences. In one embodiment, the single-sample repeated sequence removal module 110 can receive a first genetic sample sequence and a second genetic sample sequence which have undergone gene sequencing, and the first genetic sample sequence and the second genetic sample sequence correspond to the identical sample or different samples.

In one embodiment, the first genetic sample sequence can be, for example, a genetic sample sequence 300 as shown in FIG. 3. In FIG. 3, the genetic sample sequence 300 is a 16S rRNA, with a length of 1600 bp. Those of ordinary skills in the art may understand that the genetic sample sequence 300 in FIG. 3 is a schematic view of a gene sample. By applying an existing gene sequence search method, the single-sample repeated sequence removal module 110 can find conservative regions C1-C10 and variable regions V1-V10 stored in the genetic sample sequence. Herein, the conservative regions C1-C10 refer to identical or similar gene segments in the 16S rRNA of each bacterium, and the variable regions V1-V10 refer to different gene segments in the 16S rRNA of each bacterium. In one embodiment, the first genetic sample sequence can be provided with a first variable region V1, a second variable region V2, a third variable region V3, a fourth variable region V4, etc. In one embodiment, the variable regions V1-V10 can have different lengths respectively.

In addition, the second genetic sample sequence can also be a genetic sample sequence 300 as shown in FIG. 3. In one embodiment, a gene sequencing mode of the second genetic sample sequence is different from that of the first genetic sample sequence. In one embodiment, the gene sequencing mode and the gene sample length of the second genetic sample sequence are different from those of the first genetic sample sequence. Those of ordinary skills in the art may understand that a search mode of the another specific variable region in the second genetic sample sequence is the identical as that of the specific variable region in the aforesaid first genetic sample sequence, and thus it is no longer repeated herein.

By searching a specific variable region in a first genetic sample sequence and searching another specific variable region in a second genetic sample sequence, prepositioning can be performed on sample sequences to reduce the quantity of sample sequences needing query and re-sequence.

On the other hand, in one embodiment, since the 16S rRNAs of all bacteria are largely identical but with minor differences and maybe only part of variable regions are different, in the process of establishing gene sequences of known strains, the database module 150 can extract part of a variable region of some known bacterium based on an existing next generation sequencing 16S rRNA identification method, and the extracted part of the variable region is stored in the database module 150 so that the calculating and re-sequencing module 140 can compare the extracted part of the variable region with a gene sequence of a sample.

Therefore, the database module 150 can establish retrieval for known strain gene sequences of the 16S rRNA, that is, only part of a variable region of each known bacterium is extracted to serve as a gene sequence representative corresponding to each known bacterium, so as to simplify gene sequences that are searched or used for comparisons.

For example, when the database module 150 establishes a gene sequence of a known strain, a gene segment of the third variable region V3 to the fourth variable region V4 as shown in FIG. 3 is extracted, and the extracted part of the variable region is stored in the database module 150 so that in follow-up operation, the calculating and re-sequencing module 140 can make a comparison between the extracted part of the third variable region V3 to the fourth variable region V4 and the gene sequence of a sample. Besides, the detailed technological characteristics related with the comparison method will be described in details in step S240.

In one embodiment, a part of the third variable region V3 to the fourth variable region V4 is, for example, 500 bp in length, and the complete sequence length of the genetic sample sequence 300 is 1600 bp. Thus, in this embodiment, the part of third variable region V3 to the fourth variable region V4 only accounts for 30% of the complete sequence length of the genetic sample sequence 300.

As can be known from this, by means of the method, variable regions can be extracted out of the 16S rRNAs of 203 thousand currently known bacteria and are stored in the database module 150, and in follow-up operation, the calculating and re-sequencing module 140 only needs to make a comparison between a specific variable region (such as the third variable region V3 to the fourth variable region V4 in the first genetic sample sequence) in the first genetic sample sequence and/or another specific variable region (such as the third variable region V3 to the fourth variable region V4 in the second genetic sample sequence) in the second genetic sample sequence and a part of variable regions of known bacteria stored in the database module 150; and when it is determined through the compassion that both are the identical, strains corresponding to the genetic sample sequences can be determined.

In other words, by means the aforesaid technical features, when gene sequence analysis or re-sequence is performed, a comparison only needs to be made between genetic sample sequences and variable regions of representative gene sequence segments or gene sequences in the database module 150 without the need of a comparison between the whole first genetic sample sequence or the whole second genetic sample sequence and all complete data in the database module 150, and thus the calculation amount needed by the calculating and re-sequencing module in the re-sequence process can be reduced, so as to improve the speed of analyzing sample data.

In step S220, the cross-sample repeated sequence determining module 120 is used for determining whether the specific variable region and the another specific variable region have an identical cross-sample subsequence.

In one embodiment, after the specific variable region of the first genetic sample sequence and the another specific variable region of the second genetic sample sequence are searched through the single-sample repeated sequence removal module 110, if the first genetic sample sequence and the second genetic sample sequence are located in different bacterial samples, by means of the cross-sample repeated sequence determining module 120, it can be determined whether the specific variable region and the another specific variable region have the identical cross-sample subsequence.

For example, on the conditions that the specific variable region is stored in the first genetic sample sequence; the first genetic sample sequence is stored in the first bacterial sample; the another specific variable region is stored in the second genetic sample sequence and the second genetic sample sequence is stored in the second bacterial sample, if the specific variable region and the another specific variable region have a identical gene subsequence, the gene subsequence is regarded as a cross-sample subsequence.

In one embodiment, if the cross-sample repeated sequence determining module 120 determines that the specific variable region and the another specific variable region have the identical cross-sample subsequence, step S230 is executed.

In contrast, if the cross-sample repeated sequence determining module 120 determines that the specific variable region and the another specific variable region do not have the identical cross-sample subsequence, the calculating and re-sequencing module 140 directly makes a comparison between the specific variable region in the first genetic sample sequence and multiple gene sequences of known strains in the database module 150, so as to analyze the strains that are in the genetic sample sequence and correspond to the specific variable region. In other words, when some variable region only occurs in some sample and does not occur in other sample, for example, when the aforesaid specific variable region and the another specific variable region do not have the identical cross-sample subsequence, the variable region is not removed, and the calculating and re-sequencing module 140 is certain to compare the variable region with data in the database module 150.

In step S230, the repeated sequence recording module 130 is used for storing the identical cross-sample subsequence to a recording table 135 if both the specific variable region and the another specific variable region have the identical cross-sample subsequence. The identical cross-sample subsequence means a cross-sample subsequence, which can be searched from both the specific variable region of the first genetic sample sequence and the another specific variable region of the second genetic sample sequence.

In one embodiment, the repeated sequence recording module 130 is further used for recording the specific variable region corresponding to the cross-sample subsequence, the first bacterial sample which the specific variable region corresponding to the cross-sample subsequence pertains to, the another specific variable region and the second bacterial sample which the another specific variable region corresponding to the cross-sample subsequence pertains to. By recording the data, the calculation amount required during follow-up re-sequence and/or the analysis of the operational taxonomic unit can be reduced. For example, when the operational taxonomic unit is analyzed, some variable region corresponding to some cross-sample subsequence and the bacterial sample which the variable region pertain to can be traced through the recording table 13 without comparing all genetic sample sequences once again.

In step S240, the calculating and re-sequencing module 140 is used for comparing the identical cross-sample subsequence with multiple gene sequences of known strains in the database module 150 when the identical cross-sample subsequence exists, so as to analyze strains corresponding to the identical cross-sample subsequence in the first genetic sample sequence and the second genetic sample sequence.

Therefore, when the cross-sample subsequence exists, the calculating and re-sequencing module 140 extracts the cross-sample subsequence, makes a comparison between the cross-sample subsequence and all data or a part of variable regions of known strains, and records the comparison result in the recording table 135. As such, when multiple bacterial samples have the identical gene subsequence (namely the cross-sample subsequence), the calculating and re-sequencing module 140 still only needs to makes a comparison between the identical gene subsequence and the known data, so that it can be learnt that the gene subsequence corresponds to some specific known bacterium, and it can also be learnt that the bacterial samples include the specific known bacterium, without making a comparison one by one between all gene sequences related with the cross-sample subsequence in each bacterial sample.

In addition, during the follow-up calculation of the environment genosome comparison analysis, the calculating and re-sequencing module 140 can examine the recording table 135, so as to learn what strains the variable strains are positioned on and what bacterial samples the strains are located in (step S230), and thus the calculating and re-sequencing times can be reduced.

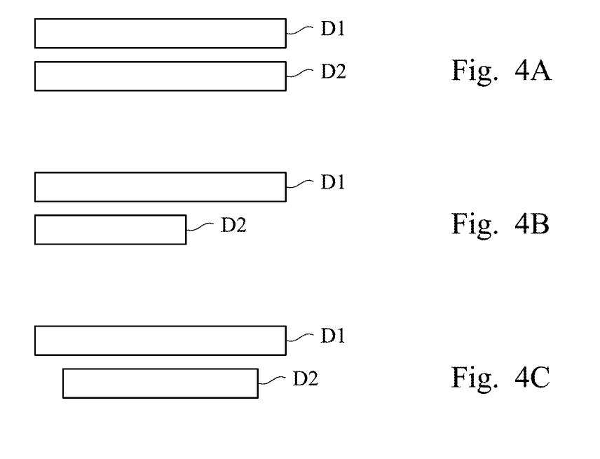

Next, referring to FIGS. 4A-4C, they illustrate schematic views of a gene fragment according to an embodiment of the present invention. A detailed method related with single sample repetition removal in steps S220 and S240 and a gene sequence comparison method are further described below.

In one embodiment, referring to FIG. 4A, the first genetic sample sequence includes a first gene fragment D1 and a second gene fragment D2. The step S210 of searching the specific variable region in the first genetic sample sequence further includes the steps of determining whether the first gene fragment D1 and the second gene fragment D2 are identical, and removing the second gene fragment D2 from the specific variable region when the first gene fragment D1 and the second gene fragment D2 are identical.

For example, when the first gene fragment D1 and the second gene fragment D2 are identical, the single-sample repeated sequence removal module 110 regards the second gene fragment D2 as one of at least one first conservative region, and thus the specific variable region can be viewed as removing (or not including) the second gene fragment D2. In addition, the calculating and re-sequencing module 140 makes a comparison between the first gene fragment D1 and gene sequences of known strains in the database module 150, so as to analyze the strain corresponding to the first gene fragment D1.

In one embodiment, referring to FIG. 4B, the first genetic sample sequence includes a first gene fragment D1 and a second gene fragment D2. When the first gene fragment D1 is longer than the second gene fragment D2, step S210 of searching the specific variable region in the first genetic sample sequence further includes the steps of determining whether the second gene fragment D2 is identical to a part of the first gene fragment D1, and removing the second gene fragment D2 from the specific variable region when the second gene fragment D2 is identical to a part of the first gene fragment D1.

For example, when the first gene fragment D1 is longer than the second gene fragment D2 and the second gene fragment D2 is identical to a part of the first gene fragment D1, the specific variable region can be viewed as removing (not including) the second gene fragment D2. In addition, the calculating and re-sequencing module 140 makes a comparison between the first gene fragment D1 and gene sequences of known strains in the database module 150, so as to analyze the strain corresponding to the first gene fragment D1.

In one embodiment, referring to FIG. 4C, herein, the first genetic sample sequence includes a first gene fragment D1 and a second gene fragment D2, and when the first gene fragment D1 is longer than the second gene fragment D2 and the second gene fragment D2 is identical to a part of the first gene fragment D1, the calculating and re-sequencing module 140 stores the second gene fragment D2 to the recording table 135.

Moreover, in one embodiment, after it is determined what strain corresponds to some gene sequence and the bacterial sample which the gene sequence pertains to is determined, the environment genosome comparison analysis can further be performed, so as to determine the proportion of beneficial bacteria or harmful bacteria in the analyzed strains and the bacterial sample which the strains pertain to. In one embodiment, cluster analysis can be further performed based on the analysis result, so as to analyze bacterial distribution conditions. For example, the number of some specific bacteria in a bacterium cluster of a cancer patient is large, and thus the health degree of the patient can be analyzed. In one embodiment, the bacterial colony function analysis can be further performed based on the analysis result, so as to determine whether the strains have beneficial bacteria or known strains related with some specific diseases, and thus the health conditions of the patient can be learned about.

In view of the above, according to the system for analyzing sequencing data of bacterial strains and a method thereof as shown in the present invention, prepositioning can be performed on sample sequences to reduce the quantity of the sample sequences needing query and re-sequence, so as to simplify gene sequences needing to be compared. The calculation amount can be reduced for the system for analyzing sequencing data of bacterial strains so that the speed of analyzing sample data can be improved.

Although the present invention has been disclosed with reference to the embodiments, these embodiments are not intended to limit the present invention. Various modifications and variations can be made by those of skills in the art without departing from the spirit and scope of the present invention, and thus the protection scope of the present invention shall be defined by the appended claims.

What is claimed is:

1. A system for analyzing sequencing data of bacterial strains, comprising:
a single-sample repeated sequence removal module for searching a first conservative region and a specific variable region in a first genetic sample sequence and removing the first conservative region;
a cross-sample repeated sequence determining module for determining whether the specific variable region has a cross-sample subsequence and the cross-sample subsequence is the same as an another specific variable region in a second genetic sample sequence;
a repeated sequence recording module, wherein when the specific variable region has the cross-sample subsequence and the cross-sample subsequence is the same as the another specific variable region in a second bacterial sample, the repeated sequence recording module is used for storing the cross-sample subsequence into a recording table;
an calculating and re-sequencing module, wherein when the cross-sample subsequence exists, the calculating and re-sequencing module is used for comparing the cross-sample subsequence with a plurality of gene sequences of known strains in a database module, so as to analyze a plurality of strains corresponding to the cross-sample subsequence in the first genetic sample sequence and the second genetic sample sequence.

2. The system for analyzing sequencing data of bacterial strains of claim 1, further comprising:
a sample sampling module for collecting a plurality of bacterial samples which comprise a first bacterial sample and a second bacterial sample; and
a gene sequencing module for respectively performing gene sequencing on the bacterial samples, so as to obtain a first genetic sample sequence corresponding to the first bacterial sample and a second genetic sample sequence corresponding to the second bacterial sample.

3. The system for analyzing sequencing data of bacterial strains of claim 2, wherein the repeated sequence recording module is further used for recording the another specific variable region corresponding to the cross-sample subsequence and the second bacterial sample which the another specific variable region corresponding to the cross-sample subsequence pertains to.

4. The system for analyzing sequencing data of bacterial strains of claim 1, wherein the first genetic sample sequence comprises a first gene fragment and a second gene fragment,
wherein, when the first gene fragment and the second gene fragment are identical, the single-sample repeated sequence removal module regards the second gene fragment as one of the at least one first conservative region, and the second gene fragment is removed from the specific variable region; and
the calculating and re-sequencing module makes a comparison between the first gene fragment and the gene sequences of the known strains stored in the database module, so as to analyze strains corresponding to the first gene fragment.

5. The system for analyzing sequencing data of bacterial strains of claim 1, wherein the first genetic sample sequence comprises a first gene fragment and a second gene fragment, and when the first gene fragment is longer than the second gene fragment and the second gene fragment is identical to a part of the first gene fragment, the calculating and re-sequencing module makes a comparison between the first gene fragment and the gene sequences of the known strains in the database module, so as to analyze a strain corresponding to the first gene fragment.

6. The system for analyzing sequencing data of bacterial strains of claim 5, wherein the first genetic sample sequence comprises a first gene fragment and a second gene fragment, and when the first gene fragment is longer than the second gene fragment and the second gene fragment is identical to a part of the first gene fragment, the calculating and re-sequencing module stores the second gene fragment in the recording table.

7. A method for analyzing sequencing of bacterial strains, comprising:
searching a specific variable region of a first genetic sample sequence and searching another specific variable region of a second genetic sample sequence;
determining whether both the specific variable region and the another specific variable region have a identical cross-sample subsequence;
if both the specific variable region and the another specific variable region have the identical cross-sample subsequence, storing the identical cross-sample subsequence to a recording table; and
when the identical cross-sample subsequence exists, comparing the identical cross-sample subsequence with a plurality of gene sequences of known strains stored in a database module, so as to analyze a plurality of strains corresponding to the identical cross-sample subsequence in the first genetic sample sequence and the second genetic sample sequence.

8. The method for analyzing sequencing of bacterial strains of claim 7, wherein the first genetic sample sequence comprises a first gene fragment and a second gene fragment, and the step of searching the specific variable region in the first genetic sample sequence comprises:
determining whether the first gene fragment and the second gene fragment are identical; and
when the first gene fragment and the second gene fragment are identical, removing the second gene fragment from the specific variable region.

9. The method for analyzing sequencing of bacterial strains of claim 7, wherein the first genetic sample sequence comprises a first gene fragment and a second gene fragment, and when the first gene fragment is longer than the second gene fragment, the step of searching the specific variable region in the first genetic sample sequence comprises:
determining whether the second gene fragment is identical to part of the first gene fragment, and
when the second gene fragment is identical to a part of the first gene fragment, removing the second gene fragment from the specific variable region.

10. The method for analyzing sequencing of bacterial strains of claim 9, comprising:
when the first gene fragment is longer than the second gene fragment and the second gene fragment is identical to a part of the first gene fragment, storing the second gene fragment into the recording table.
